(19) United States
(12) Patent Application Publication
(10) Pub. No.: US 2007/0093583 A1
(43) Pub. Date: Apr. 26, 2007

(54) Polytrimethylene terephthalate reinforced resin composition

(75) Inventor: Junko Kakegawa, Kawasaki (JP)

Correspondence Address: GREENBLUM & BERNSTEIN, P.L.C., 1950 ROLAND CLARKE PLACE, RESTON, VA, 20191, US

(73) Assignee: ASAHI KASEI CHEMICALS CORPORATION, Tokyo (JP)

(21) Appl. No.: 10/576,259

(22) PCT Filed: Oct. 28, 2004
(86) PCT No.: PCT/JP04/16008

§ 371 Date: Apr. 18, 2006

(30) Foreign Application Priority Data
Oct. 28, 2003 (JP) 2003-367249
Oct. 28, 2003 (JP) 2003-367250

(51) Int. Cl. C08K 3/22; C08K 3/26; C08K 3/34; C08K 3/40

(52) U.S. Cl. 524/413; 524/425; 524/447; 524/449; 524/451; 524/494

(57) ABSTRACT

Disclosed is a polytrimethylene terephthalate resin composition which contains 5-300 parts by weight of a crystalline inorganic filler (C) per 100 parts by weight of the total of components (A1), (A2) and (B) including 99.9-50 parts by weight of a polytrimethylene terephthalate resin (A1), 0-49.9 parts by weight of a thermoplastic resin (A2), and 0.1-20 parts by weight of an epoxy resin (B).

### TECHNICAL FIELD

The present invention relates to a polytrimethylene terephthalate reinforced resin composition excellent in appearance and having high rigidity and surface hardness, and to a molded article comprising the same. The present invention particularly relates to a polytrimethylene terephthalate reinforced resin composition which provides a molded article having good appearance and is excellent in mechanical strength, rigidity, surface hardness, dimensional stability, resistance to hydrolysis and chemical resistance, and to products prepared by using the composition, such as washroom counters, kitchen counters, bathtubs, wash bowls, hand-wash bowls and toilet counters used in baths, washrooms, toilets or kitchens.

### BACKGROUND ART

Fiber-reinforced thermosetting resins prepared by blending unsaturated polyester or acrylic thermosetting resins with glass fibers or the like have been widely used for building members in contact with water such as wash bowls, hand-wash bowls and counters used in baths, washrooms, toilets or kitchens instead of heavy and fragile ceramics. These thermosetting resin products are produced by a molding method such as press molding or casting molding.

However, thermosetting resin products are substantially unrecycable since they are crosslinked, and current waste disposal thereof is mainly by landfill. Moreover, it is difficult to compact the volume of molded articles when they are disposed of, resulting in a big problem in terms of the method of waste disposal.

Therefore, thermoplastic resin products have been receiving attention instead of thermosetting resin products, and are required to have excellent properties in that molded articles thereof have excellent appearance, mechanical strength and rigidity, as well as high performance in surface hardness, dimensional stability, resistance to hydrolysis and chemical resistance and the like.

As a procedure to improve mechanical strength, rigidity and the like of the thermoplastic resins, there is known a method to blend glass fibers. Various attempts have been made to improve heat resistance, mechanical strength and rigidity of polyester-reinforced resins by blending glass fibers.

For example, a composition consisting of a polyester resin such as polybutylene terephthalate, a mixture of polybutylene terephthalate and polyethylene terephthalate or the like, an epoxy compound, an inorganic filler and a catalyst compound has been used for the investigation of an inorganic filler-containing linear polyester having improved stability in hydrolysis and melt viscosity, these properties being unsatisfactory in polyester (refer to Patent Document 1).

Moreover, a composition consisting of a polyester resin such as polyethylene terephthalate or polybutylene terephthalate, an epoxy resin synthesized by glycidyl-etherification of a linear high-molecular weight cresol novolak having a specific number average molecular weight and a fiber-reinforcing material has been used for the investigation of improving heat resistance, mechanical properties and resistance to hydrolysis thereof (refer to Patent Document 2).

Moreover, a composition consisting of a thermoplastic resin composed of an aromatic polyester, particularly polyethylene terephthalate, or a mixture of polyethylene terephthalate and polycarbonate, and a fiber-reinforcing material surface-treated with an epoxy group-containing compound by a specific method has been investigated (refer to Patent Document 3).

However, there are problems that the resin composition prepared by blending a polybutylene terephthalate resin and an inorganic filler provides a molded article with poor appearance, and that when the composition is subjected to injection molding, the resulting molded article has a large warpage and a low dimensional stability. Moreover, under the present circumstances, a polyethylene terephthalate reinforced resin composition is difficult to be subjected to normal injection molding at a mold temperature of 100° C. or less, and molded articles with good appearance cannot be obtained.

Among reinforced polyesters, a polytrimethylene terephthalate reinforced resin composition is particularly excellent in mechanical properties, weatherability, thermal aging resistance and product appearance and can be mixed with fillers in high concentration. Therefore, a polytrimethylene terephthalate reinforced resin composition with improved mechanical properties without detriment to appearance of molded articles has been investigated (refer to Patent Documents 4 and 5).

However, when the resin composition is reinforced with glass fibers which are non-crystalline inorganic fillers, particularly when the fillers are blended in high concentration for the purpose of obtaining high rigidity, there arise problems that the glass fibers may be seen through the surface of molded articles or irregularities may be seen along the fibers, whereby the surface hardness and appearance are impaired. Consequently, it is impossible to achieve high-level appearance, surface hardness, dimensional stability, resistance to hydrolysis and chemical resistance required for building member applications in contact with water such as wash basins, hand-wash basins and counters in baths, washrooms, toilets or kitchens instead of ceramics as described above. Thus, there is a need for further improvement in this reinforced resin composition.

[Patent Document 1] JP-A-05-209117

[Patent Document 2] JP-A-06-212065

[Patent Document 3] JP-A-2002-129027

[Patent Document 4] JP-A-47-34444

[Patent Document 5] WO2002/090435

### DISCLOSURE OF THE INVENTION

Problem to be Solved by the Invention

It is an object of the present invention to provide a polytrimethylene terephthalate reinforced resin composition having excellent appearance and excellent in mechanical strength, rigidity, surface hardness, dimensional stability, resistance to hydrolysis and chemical resistance, which can be used for products such as washroom counters, kitchen counters, bathtubs, wash bowls, hand-wash bowls, toilet counters used in baths, washrooms, toilets or kitchens, and to provide a molded article using the same.

Means for Solving the Problem

As a result of intensive study to solve the problems, the present inventors have found that the requirements such as mechanical strength, rigidity, surface hardness, dimensional stability, resistance to hydrolysis, chemical resistance can be achieved by a polytrimethylene terephthalate reinforced resin composition comprising a polytrimethylene terephthalate resin (A1), a thermoplastic resin (A2), an epoxy resin (B) and a crystalline inorganic filler (C), and have completed the present invention.

Accordingly, the present invention provides the followings:
(1) A polytrimethylene terephthalate reinforced resin composition comprising 100 parts by weight of resin components consisting of 99.9 to 50 parts by weight of a polytrimethylene terephthalate resin (A1), 0 to 49.9 parts by weight of a thermoplastic resin (A2) and 0.1 to 20 parts by weight of an epoxy resin (B), and 5 to 300 parts by weight of a crystalline inorganic filler (C).
(2) The polytrimethylene terephthalate reinforced resin composition according to the above (1), wherein the composition comprises from 0.3 to 10 parts by weight of the epoxy resin.
(3) The polytrimethylene terephthalate reinforced resin composition according to the above (1) or (2), wherein the composition comprises a part of the resin components grafted on the crystalline inorganic filler in an amount from 0.01 to 5 parts by weight per 100 parts by weight of the crystalline inorganic filler.
(4) The polytrimethylene terephthalate reinforced resin composition according to any one of the above (1) to (3), wherein the composition comprises the epoxy resin in a part of the resin components not grafted on the crystalline inorganic filler in an amount from 0.1 to 20% by weight.
(5) The polytrimethylene terephthalate reinforced resin composition according to any one of the above (1) to (4), wherein the composition comprises from 2.5 to 29.7 parts by weight of the thermoplastic resin (A2).
(6) The polytrimethylene terephthalate reinforced resin composition according to any one of the above (1) to (5), wherein the thermoplastic resin (A2) is a polycarbonate resin.
(7) The polytrimethylene terephthalate reinforced resin composition according to any one of the above (1) to (6), wherein the crystalline inorganic filler is one or more inorganic fillers selected from the group consisting of wollastonite, talc, mica, kaolin, potassium titanate whiskers, calcium carbonate whiskers and barium sulfate.
(8) The polytrimethylene terephthalate reinforced resin composition according to any one of the above (1) to (7), wherein the crystalline inorganic filler is wollastonite.
(9) The polytrimethylene terephthalate reinforced resin composition according to any one of the above (1) to (8), further comprising a glass fiber (D) in an amount less than the amount of the crystalline inorganic filler (C).
(10) The polytrimethylene terephthalate reinforced resin composition according to any one of the above (1) to (9), wherein the composition comprises a part of the resin components grafted on the crystalline inorganic filler and on the glass fiber in an amount from 0.01 to 5 parts by weight per 100 parts by weight of the total of the crystalline inorganic filler and the glass fiber.
(11) The polytrimethylene terephthalate reinforced resin composition according to any one of the above (1) to (10), wherein the polytrimethylene terephthalate resin has an intrinsic viscosity [η] of 0.60 or more.
(12) The polytrimethylene terephthalate reinforced resin composition according to any one of the above (1) to (11), wherein the epoxy resin (B) is a novolac epoxy resin.
(13) The polytrimethylene terephthalate reinforced resin composition according to any one of the above (1) to (12), wherein the epoxy resin (B) is a novolac epoxy resin having an epoxy equivalent from 150 to 250 (/eq.).
(14) The polytrimethylene terephthalate reinforced resin composition according to any one of the above (1) to (11), wherein the epoxy resin (B) is a bisphenol A epoxy resin.
(15) The polytrimethylene terephthalate reinforced resin composition according to any one of the above (1) to (11) and (14), wherein the epoxy resin (B) is a bisphenol A epoxy resin having an epoxy equivalent from 600 to 3,000 (/eq.).
(16) The polytrimethylene terephthalate reinforced resin composition according to any one of the above (1) to (15), wherein the composition is produced by melt-kneading the polytrimethylene terephthalate resin (A1), the thermoplastic resin (A2) and the epoxy resin (B) and then adding the crystalline inorganic filler (C) to the melt-kneaded mixture.
(17) A molded article comprising the polytrimethylene terephthalate reinforced resin composition according to any one of the above (1) to (16).
(18) A molded article as a bath product, a washroom product, a toilet product or a sink product comprising the molded article according to the above (17) as at least a part of constituent members thereof.
(19) The molded article according to the above (18), wherein the molded article according to the above (17) is a washroom counter, a kitchen counter, a bathtub, a wash bowl, a hand-wash bowl, a toilet counter or a cabinet counter top.
(20) The molded article according to any one of the above (17) to (19), wherein a surface of the molded article has a Barcol hardness of 30 or more.

### BRIEF DESCRIPTION OF THE DRAWINGS

FIG. 1 schematically shows a hand-wash basin prepared in Example 8.

### BEST MODE FOR CARRYING OUT THE INVENTION

The present invention will be specifically described below.

The polytrimethylene terephthalate resin (A1) in the present invention (hereinafter may be abbreviated as PTT) represents a polyester polymer prepared by using terephthalic acid as an acid component and trimethylene glycol as a glycol component.

Here, trimethylene glycol is selected from 1,3-propanediol, 1,2-propanediol, 1,1-propanediol, 2,2-propanediol and a mixture thereof, and 1,3-propanediol is particularly preferred in terms of stability.

In addition, any of the following components can be copolymerized within a range which would not impair the object of the present invention: as the acid component, aromatic dicarboxylic acids other than terephthalic acid, for example, phthalic acid, isophthalic acid, 2,6-naphthalenedicarboxylic acid, diphenyldicarboxylic acid, diphenyl ether dicarboxylic acid, diphenoxyethanedicarboxylic acid, diphenylmethanedicarboxylic acid, diphenyl ketone dicarboxylic acid, diphenylsulfonedicarboxylic acid and the like; aliphatic dicarboxylic acids such as succinic acid, adipic acid and sebacic acid; cycloaliphatic dicarboxylic acids such as cyclohexanedicarboxylic acid; and oxydicarboxylic acids such as ε-oxycaproic acid, hydroxybenzoic acid and hydroxyethoxybenzoic acid; and as the glycol components, ethylene glycol, tetramethylene glycol, pentamethylene glycol, hexamethylene glycol, octamethylene glycol, neopentyl glycol, cyclohexanedimethanol, xylylene glycol, diethylene glycol, polyoxyalkylene glycol, hydroquinone and the like.

When copolymerization is carried out, the amount of the copolymerization components is not particularly limited as long as it is within a range which would not impair the object of the present invention. Typically, it is preferred that the amount be 20% by mole or less of the total acid components or 20% by mole or less of the total glycol components.

Further, the polyester components may be copolymerized with branching components, for example, trifunctional or tetrafunctional acids having ester-forming ability such as tricarballylic acid, trimesic acid and trimellitic acid, or trifunctional or tetrafunctional alcohols having ester-forming ability such as glycerin, trimethylolpropane and pentaerythritol. In this case, the amount of the branching components is 1.0% by mole or less, preferably 0.5% by mole or less, and more preferably 0.3% by mole or less, based on the total acid components or the total glycol components. Furthermore, these copolymerization components may be used in combination of two or more thereof for preparing the PTT.

The method for producing the PTT for use in the present invention is not particularly limited, but the PTT can be obtained, for example, by a method described in JP-A-51-140992, JP-A-05-262862, JP-A-08-311177 or the like.

For example, there can be mentioned a method in which terephthalic acid or an ester-forming derivative thereof (for example, lower alkyl esters such as dimethyl ester or monomethyl ester) is allowed to react with trimethylene glycol or an ester-forming derivative thereof under heating at a suitable temperature for a suitable period of time in the presence of a catalyst, and the resulting glycol ester of terephthalic acid is subjected to polycondensation to a desired degree of polymerization at a suitable temperature for a suitable period of time in the presence of a catalyst.

The polymerization method is also not particularly limited, but there can be used melt polymerization, interfacial polymerization, solution polymerization, bulk polymerization, solid-phase polymerization and combinations thereof.

The polytrimethylene terephthalate reinforced resin composition of the present invention preferably has an intrinsic viscosity [η] of 0.60 or more in terms of mechanical properties, particularly in terms of toughness, more preferably 0.68 or more, and most preferably 0.75 or more in terms of moldability, particularly in terms of flash characteristics.

For determining intrinsic viscosity [η], a resin composition is dissolved in o-chlorophenol at 35° C. such that the concentration of the solute (PTT component) is 1.00 g/dl; insolubles (such as inorganic fillers) are allowed to precipitate; and then the supernatant is used to measure specific viscosity ηsp using an Ostwald viscometer. Intrinsic viscosity [η] can be determined by the following formula:
[η]=0.713×ηsp/C+0.1086
C=1.00 g/dl

Polytrimethylene terephthalate of the present invention is optionally copolymerized or mixed with various additives, for example, heat stabilizers, antifoaming agents, orthochromatic agents, flame retardants, antioxidants, ultraviolet absorbers, infrared absorbers, crystal nucleating agents, fluorescent brightening agents, matting agents and the like.

Next, the thermoplastic resin (A2) which may be used in the present invention will be described. Thermoplastic resins refer to synthetic resins which exhibit flowability when they are heated, and which can be subjected to molding utilizing the flowability.

Specific examples of the thermoplastic resins include, for example, polycarbonate resins, polyester resins other than polytrimethylene terephthalate, polyamide resins, polyphenylene sulfide resins, polyoxymethylene resins, polyphenylene ether resins, ethylene/propylene/non-conjugated diene resins, ethylene/ethyl acrylate resins, ethylene/glycidyl methacrylate resins, ethylene/vinyl acetate/glycidyl methacrylate resins, ethylene/vinyl acetate/glycidyl methacrylate resins, ethylene/propylene-maleic anhydride resins, styrene resins or mixtures of two or more of these thermoplastic resins.

Among others, polycarbonate resins and polyester resins other than polytrimethylene terephthalate are preferred, and particularly, polycarbonate resins are most preferred in terms of mechanical properties.

Polycarbonate resins are produced from a divalent phenol and a carbonate precursor by a melting method or a solution method. Specifically, the polycarbonate resins can be produced, in a solvent such as methylene chloride in the presence of a known acid acceptor and a molecular weight modifier, by a reaction between a divalent phenol and a carbonate precursor such as phosgene, or by an ester exchange reaction between a divalent phenol and a carbonate precursor such as diphenyl carbonate. Here, preferred divalent phenols include bisphenols, particularly 2,2-bis(4-hydroxyphenyl)propane, that is, bisphenol A. In addition, a part or all of the bisphenol A may be replaced with a divalent phenol.

Divalent phenols other than bisphenol A may include compounds such as hydroquinone, 4,4-dihydroxydiphenyl, bis(4-hydroxyphenyl)alkane, bis(4-hydroxyphenyl)cycloalkane, bis(4-hydroxyphenyl)sulfide, bis(4-hydroxyphenyl)sulfone, bis(4-hydroxyphenyl)sulfoxide and bis(4-hydroxyphenyl)ether. These divalent phenols may be homopolymers of divalent phenols or copolymers of two or more thereof.

Moreover, the carbonate precursors may include carbonyl halides, carbonyl esters and the like, but phosgene, diphenyl carbonate or a mixture thereof is preferably used. The polycarbonate resins used in the present invention preferably have a weight average molecular weight (MW) ranging from 5,000 to 200,000, more preferably from 15,000 to 40,000.

The polyester resins are not particularly limited as long as they are polyester resins other than polytrimethylene terephthalate, but a known polyester resin or a combination of two or more thereof may be used.

The polyamide resins are not particularly limited, but a known polyamide resin or a combination of two or more thereof may be used. Particularly suitable polyamide resins include polycaprolactam (nylon 6), polyhexamethylene adipamide (nylon 66), polyhexamethylene dodecamide (nylon 612), polyhexamethylene isophthalamide (nylon 6I) or a polyamide copolymer containing at least two different polyamides among the above.

The styrene resins include polystyrene resins, rubber-modified polystyrene resins, AS resins, ABS resins or combinations thereof.

The epoxy resin (B) of the present invention refers to a thermosetting compound having two or more epoxy groups (oxirane rings) in a molecule. Specific examples include so called bisphenol A epoxy resins produced by a condensation reaction between bisphenol A and epichlorohydrin, bisphenol S epoxy resins, bisphenol F epoxy resins, resorcinol epoxy resins, novolac epoxy resins which are polyfunctional epoxy prepared by the glycidylation of phenol novolac or a linear high-molecular weight cresol novolac, aliphatic epoxy resins, cycloaliphatic epoxy resins, polyglycidylamine epoxy and the like.

A novolac epoxy resin having an epoxy equivalent from 150 to 280 (/eq) or a bisphenol A epoxy resin having an epoxy equivalent from 600 to 3,000 (/eq) is suitably used as the epoxy resin for use in the present invention in terms of chemical resistance and dispersibility in the resins. More preferably, there is used a novolac epoxy resin having an epoxy equivalent from 180 to 250 (/eq) and a molecular weight from 1,000 to 6,000, or a bisphenol A epoxy resin having an epoxy equivalent from 600 to 3,000 (/eq) and a molecular weight from 1,200 to 6,000.

The polytrimethylene terephthalate (A1) and the thermoplastic resin (A2) are blended in an amount from 99.9 to 50 parts by weight and from 0 to 49.9 parts by weight, respectively, in terms of appearance and surface hardness, wherein the blending amount of the thermoplastic resin (A2) does not exceed that of the polytrimethylene terephthalate resin (A2). More preferably, the polytrimethylene terephthalate (A1) is blended in an amount from 97.2 to 70 parts by weight, and the thermoplastic resin (A2) is blended from 2.5 to 29.7 parts by weight.

The blending amount of the epoxy resin (B) is from 0.1 to 20% by weight, more preferably from 0.3 to 10% by weight, in terms of mechanical properties, surface hardness, chemical resistance and prevention of reduction of flowability.

Next, the crystalline inorganic filler (C) of the present invention will be described.

The crystalline inorganic filler according to the present invention refers to crystalline inorganic fillers excluding non-crystalline fillers such as glass fibers, glass flakes and glass beads, in which a diffraction pattern of the crystals can be observed by X-ray diffraction. One or more inorganic fillers selected from the group consisting of fibrous, powdery/particulate and plate-like inorganic fillers can be used depending on the purposes. The crystalline inorganic fillers can be used to obtain molded articles having high surface appearance, rigidity and surface hardness which have not been achieved by using non-crystalline inorganic fillers.

The fibrous inorganic fillers include inorganic fibrous materials such as carbon fibers, silica fibers, silica-alumina fibers, zirconia fibers, boron nitride fibers, silicon nitride fibers, boron fibers, potassium titanate whiskers, calcium carbonate whiskers, wollastonite, fibrous materials composed of metal such as stainless steel, aluminum, titanium, copper or brass, and the like.

The average fiber length (L), average fiber diameter (D) and aspect ratio (L/D) of the fibrous inorganic filler are not particularly limited, but preferably, the average fiber length is 50 μm or more; the average fiber diameter is 5 μm or more; and the aspect ratio is 10 or more, in terms of mechanical properties. Carbon fibers having an average fiber length from 100 to 750 μm, an average fiber diameter from 3 to 30 μm and an aspect ratio from 10 to 100 are suitably used. In addition, wollastonite having an average fiber length from 3 to 30 μm, an average fiber diameter from 10 to 500 μm and an aspect ratio from 3 to 100 is suitably used.

Powdery/particulate inorganic fillers include carbon black, silica, quartz powder, silicates such as calcium silicate, aluminum silicate, kaolin, clay and diatomaceous earth, metal oxides such as iron oxide, titanium oxide, zinc oxide and alumina, metal carbonates such as calcium carbonate and magnesium carbonate, metal sulfates such as calcium sulfate and barium sulfate, silicon carbide, silicon nitride, boron nitride and various metal powders.

The plate-like inorganic fillers include talc, mica, various metal foils and the like. Talc, mica, kaolin, calcium carbonate and potassium titanium each having an average particle size from 0.1 to 100 μm are suitably used.

The inorganic filler of the present invention preferably comprises one or more crystalline inorganic fillers selected from the group consisting of wollastonite, talc, mica, kaolin, calcium carbonate, carbon fibers (CF), potassium titanate whiskers, calcium carbonate whiskers and barium sulfate, in terms of appearance and mechanical strength, most preferably wollastonite.

The blending amount of the crystalline inorganic filler (C) is from 5 to 300 parts by weight, preferably from 25 to 250 parts by weight based on 100 parts by weight of the total of the trimethylene terephthalate resin (A1), thermoplastic resin (A2) and epoxy resin (B), in terms of the effect to improve mechanical strength, rigidity and surface hardness and influence to appearance such as reduction in gloss of the surface of molded articles.

Moreover, the present invention may further comprise a glass fiber (D) in combination with the crystalline inorganic filler (C) in terms of mechanical strength.

When the glass fiber (D) is used in the range not exceeding the blending amount of the crystalline inorganic filler (C), it is possible to minimize poor appearance in the case of using the glass fiber alone, provide excellent surface appearance and improve mechanical strength. Preferably, from 3 to 200 parts by weight of the crystalline inorganic filler (C) and from 2 to 100 parts by weight of the glass fiber (D) are blended with 100 parts by weight of the total of the polytrimethylene terephthalate resin (A1), thermoplastic resin (A2) and epoxy resin (B).

In the present invention, a resin grafted on the surface of the inorganic filler is preferably caused to be present in a specific proportion in the polytrimethylene terephthalate resin composition.

Here, the resin grafted on the surface of the inorganic filler refers to an organic substance layer containing polytrimethylene terephthalate as a main component which remains on the surface of the inorganic filler without being eluted into a solvent for polyester resins when the polytrimethylene terephthalate reinforced resin composition is immersed in the solvent to elute polytrimethylene terephthalate and to precipitate the inorganic filler.

Specifically, the polytrimethylene terephthalate resin composition is first mixed with a HFIP (hexafluoroisopropanol) solvent in order to separate the inorganic filler and a resin which is not grafted on the inorganic filler in the polytrimethylene terephthalate reinforced resin composition. The HFIP solution part, in which the resin mainly composed of polytrimethylene terephthalate is dissolved, is then removed, and the remaining inorganic filler part is washed with the HFIP solvent several times until polytrimethylene terephthalate is not eluted. Then, the inorganic filler part is washed with ethanol several times in order to remove HFIP, and the ethanol is removed by drying. Thus, the inorganic filler grafted with the organic substance layer is taken out of the resin composition. The organic substance layer grafted on the inorganic filler refers to “a resin grafted on the inorganic filler”.

The amount of resin grafted on the surface of the inorganic filler can be determined by the following expression according to JIS R3420 (Ignition Loss) by using the inorganic filler grafted with the resin obtained as described above.
Amount of grafted-resin (parts by weight)=[(W0−W1)/W1]×100

W0: weight of the inorganic filler grafted with the resin before burning

W1: weight of the inorganic filler after burning

(When glass fiber is used in combination with the crystalline filler, the amount can be determined as the amount of the resin grafted on the surface of the inorganic fillers combining the both.)

The amount of the resin grafted on the surface of the inorganic filler (when glass fiber is used in combination with the crystalline filler, the amount of the resin grafted on the surface of inorganic fillers combining the both) is from 0.01 to 5 parts by weight, preferably from 0.02 to 3 parts by weight, and most preferably from 0.05 to 2 parts by weight, per 100 parts by weight of the inorganic filler. The mechanical strength of the resulting composition will not be sufficient if the amount is less than 0.01 parts by weight. If the amount exceeds 5 parts by weight, melt flowability will be reduced, resulting in increase of the pressure during injection molding.

In the present invention, in order that the resin grafted on the surface of the inorganic filler in the polytrimethylene terephthalate resin composition may present at a specific proportion, crystalline inorganic filler (C) and glass fiber (D) which can be used in combination are preferably surface-treated.

The surface treatment of the inorganic filler is not particularly limited, but it may be performed by using a coupling agent or a film-forming agent.

The coupling agent may include silane coupling agents and titanium coupling agents. Specifically, amino silanes and epoxy silanes such as γ-aminopropyltrimethoxysilane, N-β-(aminoethyl)-γ-aminopropyltrimethoxysilane, γ-glycidoxypropyltrimethoxysilane, β-(1,1-epoxycyclohexyl)ethyltrimethoxysilane are suitably used since they are excellent in cost-effectiveness and easily handled.

The film-forming agent may include polymers such as urethane polymers, acrylic acid polymers, copolymers of maleic anhydride with unsaturated monomer such as ethylene, styrene, α-methylstyrene, butadiene, isoprene, chloroprene, 2,3-dichlorobutadiene, 1,3-pentadiene and cyclooctadiene, epoxy polymers, polyester polymers and polyether polymers. Among others, epoxy polymers, urethane polymers, acrylic acid polymers, butadiene-maleic anhydride copolymers, ethylene-maleic anhydride copolymers, styrene-maleic anhydride copolymers and combination thereof are most preferably used in terms of excellent cost-effectiveness and mechanical strength.

Inorganic fillers can be surface-treated with these coupling agents and film-forming agents by known methods, which may include, for example, sizing treatment in which a solution or suspension consisting of the above coupling agent and/or film-forming agent and an organic solvent is applied to the surface as a so-called sizing agent; dry blend in which the coupling agent and/or film-forming agent is applied using a Henschel mixer, a super mixer, a Redi mixer, V-blender or the like; a spray method in which the coupling agent and/or film-forming agent is applied by spraying; as well as an integral blend method and a dry concentrate method. A combined method thereof may also be included, for example, applying the coupling agent and a part of the film-forming agent by the sizing treatment followed by spraying the remainder of the film-forming agent. Among others, sizing treatment, dry blend, a spray method and a combined method thereof are preferably used in terms of excellent cost-effectiveness.

Moreover, in the present invention, the amount of the epoxy resin in a resin which is not grafted on the inorganic filler, defined as the resin composition from which the inorganic filler and a resin grafted on the inorganic filler are excluded, is preferably a specific amount. The resin which is not grafted on the inorganic filler can be separated as a part of the HFIP solution part in which a resin mainly composed of polytrimethylene terephthalate is dissolved, in the operation for separating the inorganic filler grafted with the resin.

The amount of the epoxy resin in the resin which is not grafted on the inorganic filler can be determined by quantitatively analyzing the organic substance, for example, using nuclear magnetic resonance (NMR).

The amount of the epoxy resin in the resin which is not grafted on the inorganic filler is preferably from 0.1 to 20% by weight, more preferably from 0.3 to 10% by weight. The presence of the epoxy resin in an amount of 0.1% by weight or more in the resin which is not grafted on the inorganic filler can enhance mechanical strength, rigidity and surface hardness; remarkably improve chemical resistance and resistance to hydrolysis; and prevent reduction of the molecular weight of the resin composition caused by the blending of the inorganic filler. If the amount exceeds 20% by weight, melt flowability will be reduced, resulting in increase of the pressure during injection molding.

The polytrimethylene terephthalate reinforced resin composition of the present invention can be obtained by melt kneading polytrimethylene terephthalate, a thermoplastic resin, a crystalline inorganic filler, a glass fiber which is optionally mixed and other additives using an extruder having a screw suitably designed. Specifically, a production method in which the polytrimethylene terephthalate resin (A1), the thermoplastic resin (A2) and the epoxy resin (B) are melt kneaded and then the crystalline inorganic filler (C) is added therein is preferred in that it effectively disperses the epoxy resin in the resin; it controls the amount of the resin grafted on the surface of the inorganic filler; and it suppresses the reduction of the molecular weight of the resin composition caused by the addition of the inorganic filler.

In addition to the polytrimethylene terephthalate resin, thermoplastic resin, epoxy resin, crystalline inorganic filler and glass fiber, the polytrimethylene terephthalate reinforced resin composition of the present invention can be appropriately blended with other components depending on various applications and purposes.

For example, the composition of the present invention can be further blended with a crystal nucleating agent. Both organic and inorganic substances can be used as the crystal nucleating agent.

Moreover, the resin composition of the present invention can be further blended with a moldability improver. The moldability improver includes phosphates, phosphites, higher fatty acids, higher fatty acid metal salts, higher fatty acid esters, higher fatty acid amide compounds, polyalkylene glycol or terminal-modified compounds thereof, low molecular weight polyethylenes or oxidized low molecular weight polyethylenes, substituted benzylidene sorbitols, polysiloxanes and caprolactones, and higher fatty acids, higher fatty acid metal salts and higher fatty acid esters are most preferred.

Furthermore, the resin composition of the present invention can be blended with typically used additives such as flame retardants, ultraviolet absorbers, heat stabilizers, antioxidants, plasticizers, colorants, orthochromatic agents, antistatic agents, fluorescent brightening agents, matting agents and impact modifiers within a range which would not impair the object of the present invention.

The polytrimethylene terephthalate reinforced resin composition of the present invention has excellent appearance, mechanical strength, rigidity, dimensional stability, resistance to hydrolysis and chemical resistance. Accordingly, the composition can be used for at least a part of the components of the products such as washroom counters, kitchen counters, bathtubs, wash bowls (wash basins), hand-wash bowls (hand-wash basins), various sinks, toilet counters and cabinet counter tops used in baths, washrooms, toilets or kitchens. Specifically, molded articles composed of the composition of the present invention, in which the surface hardness of the molded articles is a Barcol hardness of 30 or more and a pencil hardness of 2H or more, more preferably a Barcol hardness of 40 or more and a pencil hardness of 3H or more, can be most suitably employed in the applications.

### EXAMPLES

The present invention will now be described with reference to Examples. Those resins used in Examples and Comparative Examples are described below.

(A) Resin

PTT resin: polytrimethylene terephthalate resin [η]=1.0
PBT resin: polybutylene terephthalate resin, Duranex 2002, manufactured by Polyplastics Co., Ltd.
Resin: polycarbonate resin, Iupilon S2000, manufactured by Mitsubishi Engineering-Plastics Corporation
   (B) Epoxy Resin
Epoxy resin-1: bisphenol A epoxy resin AER ECN6097, epoxy equivalent about 2,000 (/eq), manufactured by Asahi Chemical Epoxy Co., Ltd.
Epoxy resin-2: ortho-cresol novolac epoxy resin AER ECN1299, epoxy equivalent about 230 (/eq), manufactured by Asahi Chemical Epoxy Co., Ltd.
   (C) Crystalline Inorganic Filler
MF-1: Wollastonite, NYGLOSS8 treated with epoxy-silane, manufactured by NICO
MF-2: Wollastonite, NYGLOSS8 treated with amino-silane, manufactured by NICO
MF-3: Mica, M-400, manufactured by Repco
MF-4: Barium sulfate, BMH-60, manufactured by Sakai Chemical Industry Co., Ltd.
   (D) Glass Fiber
O3T-187/PL, manufactured by Nippon Electric Glass Co., Ltd.

Evaluation methods are as follows:

(1) Flexural Modulus (GPa)

Flexural modulus was measured according to ASTM D790.

(2) Appearance

Dumbbell specimens were measured for Gs 20° according to JIS K7150 using a handy gloss meter IG320 manufactured by Horiba, Ltd.

(3) Surface Hardness

The surface of molding articles was measured for Barcol hardness according to JIS K7060.

(4) Chemical Resistance

Molded articles were immersed in a drain-pipe-cleaner stock solution for 2 weeks at room temperature. Then, they were taken out, washed with water and dried for measuring the weight change of the molded articles.

Cleaner used: Pipe Unish Plus (3% sodium hydroxide, hypochlorite, alkylamine oxide surfactant), manufactured by Johnson Co., Ltd.

### Example 1

The PTT resin and epoxy resin were mixed with a blending ratio as shown in Table 1 and melt kneaded with a twin-screw extruder (TEM 58: manufactured by Toshiba Machine Co., Ltd.), to which the crystalline inorganic filler was added from a side feeder in the blending ratio as shown in Table 1. The extrusion conditions were as follows: screw speed 150 rpm, cylinder temperature 260° C., extrusion rate 150 kg/hr, vacuum degree 0.04 MPa and resin temperature around the tip nozzle 280° C. The composition discharged from the tip nozzle in a strand form was cooled with water and then cut to pellets. The pellets were dried in a dehumidification dryer at 120° C. for 5 hours. The dried pellets were then subjected to injection molding by means of the PS40E injection molding machine manufactured by Nissei Plastic Industry Co., Ltd. at a cylinder temperature of 260° C. and a mold temperature of 90° C. to prepare specimens. These specimens were used for evaluation. The results are shown in Table 1.

Determination of the Amount of Resin Grafted on the Surface of Inorganic Fillers

To 100 ml of the HFIP (hexafluoroisopropanol) solvent was added 5 g of the resin composition to dissolve polytrimethylene terephthalate, and the solution part was separated by centrifugation (for 30 minutes at 25,000 rpm). To a centrifuge tube was added 25 ml of HFIP, and the resulting mixture was subjected to ultrasonic cleaning for 30 minutes. Then, the solution part was separated by centrifugation. This operation was repeated 5 times, and the remainder of the composition was dried at 80° C. for 10 hours. The resulting inorganic filler was put in a platinum crucible and weighed, and then burned at 650° C. for 1 hour. The inorganic filler after burning was weighed. The amount of resin grafted on the inorganic filler was determined by the following expression, as the amount of grafted resin per 100 parts by weight of the inorganic filler (parts by weight):
Amount of grafted-resin per 100 parts by weight of the inorganic filler (parts by weight)=[(W0−W1)/W1]×100
wherein W0 denotes the weight of the inorganic filler before burning, and W1 denotes the weight of the inorganic filler after burning.
The amount of grafted-resin was 1.85% by weight.

### Example 2 and Comparative Examples 1 to 4

Specimens were prepared according to the procedures similar to those in Example 1, and these specimens were used for evaluation. In Comparative Examples 3 and 4, the glass fiber was used as the inorganic filler. However, since separation of the filler was observed for the same amount of filler as in Example 1, the amount of filler was reduced to 100 parts by weight. The results are shown in Table 1.

TABLE 1

| | | | Example | Example | Comparative | Comparative | Comparative | Comparative |
|---|---|---|---|---|---|---|---|---|
| | | | 1 | 2 | Example 1 | Example 2 | Example 3 | Example 4 |
| Composition | (A) Resin | | | | | | | |
| (parts by | | PTT resin | 95 | 85 | | 89.5 | 97 | 81 |
| weight) | | PBT resin | | | 85 | | | |
| | (A2) PC resin | | | 10 | 10 | 10.5 | | 14 |
| | (B) Epoxy resin | | | | | | | |
| | | Epoxy resin-1 | 5 | | | | 3 | 5 |
| | | Epoxy resin-2 | | 5 | 5 | | | |
| | (C) Inorganic filler | | | | | | | |
| | | MF-1 | 150 | 150 | 150 | 150 | | |
| | | MF-2 | | | | | | |
| | (C2) Glass fiber | | 0 | 0 | 0 | 0 | 100 | 100 |
| Evaluation | Flexural | GPa | 19.9 | 19.8 | 18.0 | 18.7 | 15.6 | 15.7 |
| | modulus | | | | | | | |
| | Appearance | (Gs20° %) | 47 | 46 | 39 | 44 | 35 | 38 |
| | Surface | (Barcol | 45 | 46 | 34 | 40 | 32 | 35 |
| | hardness | hardness) | | | | | | |
| | Chemical | (weight | −0.02 | −0.01 | −0.03 | −0.12 | −0.03 | −0.01 |
| | resistance | change %) | | | | | | |

### Example 3

According to the procedures similar to those in Example 1, the PTT resin and epoxy resin were mixed with a blending ratio as shown in Table 2 and melt kneaded with a twin-screw extruder (TEM 58: manufactured by Toshiba Machine Co., Ltd.), to which the crystalline inorganic filler and glass fiber were added from a side feeder in the blending ratio as shown in Table 2. The extrusion conditions were as follows: screw speed 150 rpm, cylinder temperature 260° C., extrusion rate 150 kg/hr, vacuum degree 0.04 MPa and resin temperature around the tip nozzle 282° C. The composition discharged from the tip nozzle in a strand form was cooled with water and then cut to pellets. The pellets were dried in a dehumidification dryer at 120° C. for 5 hours. Specimens were then injection molded from the dried pellets using the PS40E injection machine manufactured by Nissei Plastic Industry Co., Ltd., wherein the cylinder temperature and mold temperature were set at 260° C. and 95° C., respectively. The specimens were used for evaluation. The results are shown in Table 2.

In addition, the amount of resin grafted on the surface of the inorganic filler and glass fiber was determined according to the procedures similar to those in Example 1. The amount of grafted-resin was 1.61% by weight.

### Examples 4 to 7 and Comparative Examples 5 to 9

Specimens were prepared according to the procedures similar to those in Example 3, and these specimens were used for evaluation. The results are shown in Table 2. Incidentally, in Comparative Example 5, it was impossible to produce the composition because the filler was separated from the resin.

TABLE 2

| | | | Example 3 | Example 4 | Example 5 | Example 6 | Example 7 |
|---|---|---|---|---|---|---|---|
| Composition | (A) Resin | | | | | | |
| (parts by | | PTT resin | 95 | 90 | 85 | 85 | 82 |
| weight) | | PBT resin | | | | | |
| | (A2) PC resin | | 0 | 5 | 10 | 10 | 10 |
| | (B) Epoxy resin | | | | | | |
| | | Epoxy resin-1 | 5 | | 5 | | 8 |
| | | Epoxy resin-2 | | 5 | | 5 | |
| | (C) Inorganic filler | | | | | | |
| | | MF-1 | 112.5 | 112.5 | | | |
| | | MF-2 | | | 112.5 | | |
| | | MF-3 | | | | 112.5 | |
| | | MF-4 | | | | | 112.5 |
| | (C2) Glass fiber | | 37.5 | 37.5 | 37.5 | 37.5 | 37.5 |
| Evaluation | Flexural | GPa | 17.8 | 18.0 | 18.2 | 18.5 | 12.5 |
| | modulus | | | | | | |
| | Appearance | (Gs20° %) | 50 | 51 | 48 | 52 | 58 |
| | Surface | (Barcol | 45 | 48 | 43 | 46 | 37 |
| | hardness | hardness) | | | | | |
| | Chemical | (weight | −0.01 | −0.03 | −0.01 | −0.03 | −0.05 |
| | resistance | change %) | | | | | |

| | | | Comparative | Comparative | Comparative | Comparative | Comparative |
|---|---|---|---|---|---|---|---|
| | | | Example 5 | Example 6 | Example 7 | Example 8 | Example 9 |
| Composition | (A) Resin | | | | | | |
| (parts by | | PTT resin | | | 100 | 94.4 | 85 |
| weight) | | PBT resin | 85 | 82 | | | |
| | (A2) PC resin | | 10 | 10 | | 5.6 | 10 |
| | (B) Epoxy resin | | | | | | |
| | | Epoxy resin-1 | 5 | 8 | | | 5 |
| | | Epoxy resin-2 | | | | | |
| | (C) Inorganic filler | | | | | | |
| | | MF-1 | | | 112.5 | 112.5 | 37.5 |
| | | MF-2 | 112.5 | | | | |
| | | MF-3 | | | | | |
| | | MF-4 | | 112.5 | | | |
| | (C2) Glass fiber | | 37.5 | 37.5 | 37.5 | 37.5 | 112.5 |
| Evaluation | Flexural | GPa | impossible | 10.8 | 16.0 | 16.3 | 15.2 |
| | modulus | | to produce | | | | |
| | Appearance | (Gs20° %) | impossible | 48 | 50 | 49 | 38 |
| | | | to produce | | | | |
| | Surface | (Barcol | impossible | 20 | 40 | 42 | 35 |
| | hardness | hardness) | to produce | | | | |
| | Chemical | (weight | impossible | −0.15 | −0.12 | −0.10 | −0.05 |
| | resistance | change %) | to produce | | | | |

### Example 8

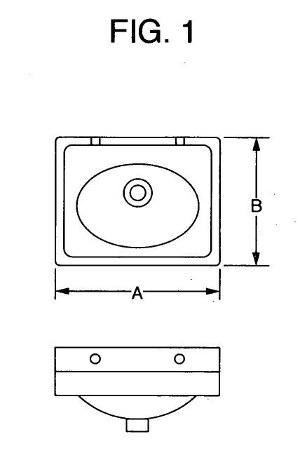

The pellets prepared in Example 4 were dried in a dehumidification dryer at 120° C. for 5 hours. The dried pellets were then subjected to injection molding by means of the J650ELIII-3100H injection molding machine manufactured by Japan Steel Works, Ltd. at a cylinder temperature of 270° C. and a mold temperature of 95° C. to mold a hand-wash basin as shown in FIG. 1 (A=400 mm, B=320 mm, depth of the basin part 125 mm, height of the rising part from the washstand 60 mm, drain hole φ=30 mm, mounting hole φ=10 mm). The surface of the basin part of the obtained molded article had a Barcol hardness of 48 and a pencil hardness of 4H, and the top flat part of the molded article had a GS20° of 52%. Further, the drain-pipe-cleaner stock solution was put in the molded article and was left standing for 2 weeks. It was verified that the appearance of the molded article did not change.

### INDUSTRIAL APPLICABILITY

The polytrimethylene terephthalate reinforced resin composition of the present invention provides a molded article having good appearance and is excellent in mechanical strength, rigidity, surface hardness, dimensional stability, resistance to hydrolysis and chemical resistance. The products such as washroom counters, kitchen counters, bathtubs, wash bowls, hand-wash bowls, toilet counters and cabinet counter tops all composed of the resin composition have excellent performance and can be used as a substitute for ceramic and thermosetting resin products used in baths, washrooms, toilets or kitchens. Moreover, these products can be used for recycling. For example, they can be reworked and used as a part of the raw materials for molding.

1. A polytrimethylene terephthalate reinforced resin composition comprising 100 parts by weight of resin components consisting of 99.9 to 50 parts by weight of a polytrimethylene terephthalate resin (A1), 0 to 49.9 parts by weight of a thermoplastic resin (A2) and 0.1 to 20 parts by weight of an epoxy resin (B), and 5 to 300 parts by weight of a crystalline inorganic filler (C).

2. The polytrimethylene terephthalate reinforced resin composition according to claim 1, wherein the composition comprises from 0.3 to 10 parts by weight of the epoxy resin.

3. The polytrimethylene terephthalate reinforced resin composition according to claim 1, wherein the composition comprises a part of the resin components grafted on the crystalline inorganic filler in an amount from 0.01 to 5 parts by weight per 100 parts by weight of the crystalline inorganic filler.

4. The polytrimethylene terephthalate reinforced resin composition according to claim 1, wherein the composition comprises the epoxy resin in a part of the resin components not grafted on the crystalline inorganic filler in an amount from 0.1 to 20% by weight.

5. The polytrimethylene terephthalate reinforced resin composition according to claim 1, wherein the composition comprises from 2.5 to 29.7 parts by weight of the thermoplastic resin (A2).

6. The polytrimethylene terephthalate reinforced resin composition according to claim 1, wherein the thermoplastic resin (A2) is a polycarbonate resin.

7. The polytrimethylene terephthalate reinforced resin composition according to claim 1, wherein the crystalline inorganic filler is one or more inorganic fillers selected from the group consisting of wollastonite, talc, mica, kaolin, potassium titanate whiskers, calcium carbonate whiskers and barium sulfate.

8. The polytrimethylene terephthalate reinforced resin composition according to claim 1, wherein the crystalline inorganic filler is wollastonite.

9. The polytrimethylene terephthalate reinforced resin composition according to claim 1, further comprising a glass fiber (D) in an amount less than the amount of the crystalline inorganic filler (C).

10. The polytrimethylene terephthalate reinforced resin composition according to claim 1, wherein the composition comprises a part of the resin components grafted on the crystalline inorganic filler and on the glass fiber in an amount from 0.01 to 5 parts by weight per 100 parts by weight of the total of the crystalline inorganic filler and the glass fiber.

11. The polytrimethylene terephthalate reinforced resin composition according to claim 1, wherein the polytrimethylene terephthalate resin has an intrinsic viscosity of 0.60 or more.

12. The polytrimethylene terephthalate reinforced resin composition according to claim 1, wherein the epoxy resin (B) is a novolac epoxy resin.

13. The polytrimethylene terephthalate reinforced resin composition according to claim 1, wherein the epoxy resin (B) is a novolac epoxy resin having an epoxy equivalent from 150 to 250 (/eq.).

14. The polytrimethylene terephthalate reinforced resin composition according to claim 1, wherein the epoxy resin (B) is a bisphenol A epoxy resin.

15. The polytrimethylene terephthalate reinforced resin composition according to claim 1, wherein the epoxy resin (B) is a bisphenol A epoxy resin having an epoxy equivalent from 600 to 3,000 (/eq.).

16. The polytrimethylene terephthalate reinforced resin composition according to claim 1, wherein the composition is produced by melt-kneading the polytrimethylene terephthalate resin (A1), the thermoplastic resin (A2) and the epoxy resin (B) and then adding the crystalline inorganic filler (C) to the melt-kneaded mixture.

17. A molded article comprising the polytrimethylene terephthalate reinforced resin composition according to claim 1.

18. A molded article as a bath product, a washroom product, a toilet product or a sink product comprising the molded article according to claim 17 as at least a part of constituent members thereof.

19. The molded article according to claim 18, wherein the molded article is a washroom counter, a kitchen counter, a bathtub, a wash bowl, a hand-wash bowl, a toilet counter or a cabinet counter top.

20. The molded article according to claim 17, wherein a surface of the molded article has a Barcol hardness of 30 or more.
